(19) United States
(12) Patent Application Publication
(10) Pub. No.: US 2004/0039948 A1
(43) Pub. Date: Feb. 26, 2004

(54) Portable computer and method of controlling the same

(75) Inventor: Kyoung-Won Lee, Seoul City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon City (KR)

(21) Appl. No.: 10/388,424

(22) Filed: Mar. 17, 2003

(30) Foreign Application Priority Data
Aug. 7, 2002 (KR) 2002-46608

(51) Int. Cl. G06F 1/30

(52) U.S. Cl. 713/300

(57) ABSTRACT

A portable computer having a power supply receiving electric power from an adapter or a battery; an LCD device displaying a picture based on a vertical frequency transmitted from a video chip; and a microprocessor determining whether the power supply receives the electric power from the adapter or the battery, and outputting a determined power source information. A controller in the computer controls the video chip according to the power source information to change the vertical frequency for the LCD device. The controller lowers the vertical frequency when the power supply receives the electric power from the battery to reduce power consumption while being operated by the battery.

### CROSS-REFERENCE TO RELATED APPLICATIONS

This application claims the benefit of Korean Application No. 2002-46608 filed Aug. 7, 2002, in the Korean Intellectual Property Office, the disclosure of which is incorporated herein by reference.

### BACKGROUND OF THE INVENTION

1. Field of the Invention

The present invention relates to a portable computer, and more particularly, to a portable computer and a method of controlling the same, in which a vertical frequency of an LCD device can be altered.

2. Description of the Related Art

In comparison with a desktop computer, a portable computer is small and handy to carry, and accordingly, the portable computer is being widely used.

Generally, the portable computer comprises a main body provided with hardware components, such as a video chip, a hard disk drive, a memory, a microprocessor, etc., an LCD (liquid crystal display) device combined to the main body with hinges and displaying a picture based on a video signal transmitted from the main body, and a power supply supplying electric power to the main body and the LCD device.

The power supply of the portable computer receives the electric power from a wall outlet through an AC adapter (adapter) or receives the electric power from a battery. However, in the case of the battery, a capacity of the battery is limited, so that the portable computer can be used with the battery for a limited time. To increase the using time of the portable computer, there have been proposed various power management methods in hardware or software.

On the other hand, when a user turns on the portable computer, the LCD device is initialized in a POST (power on self test) procedure. At this time, a vertical frequency for the LCD device is set up. Presently, most of the LCD devices are manufactured to optimally operate (display) at the vertical frequency of 60 Hz. Herein, the higher the vertical frequency of the LCD device, the more electric power is consumed. Hence, in the case where the portable computer is operated by the battery, if the vertical frequency of the LCD device can be lowered to less than 60 Hz, the power consumption can be reduced, thereby increasing the using time of the portable computer. And, according to a recently developed LCD device, even if the vertical frequency therefor is lowered to 50 Hz, a user can hardly recognize (notice) the change of the vertical frequency in the display of images or video.

However, in the conventional portable computer, once the LCD device is initialized, the vertical frequency therefore cannot be changed regardless of using either the adapter or the battery. Thus, to reduce power consumption while being operated by a battery, the conventional portable computer only lowers the brightness of a back light, allowing the LCD device to lighten.

### SUMMARY OF THE INVENTION

Accordingly, the present invention provides a portable computer and a method of controlling the same, which can reduce power consumption by lowering a vertical frequency of an LCD device while being operated by a battery.

Additional aspects and advantages of the invention will be set forth in part in the description which follows and, in part, will be obvious from the description, or may be learned by practice of the invention.

The present invention can be achieved by providing a portable computer comprising a power supply receiving electric power from an adapter or a battery; a system board mounted with a BIOS ROM storing information controlling peripheral devices, such as a video chip, etc.; an LCD device displaying a picture based on a vertical frequency transmitted from the video chip; a microprocessor determining whether the power supply receives the electric power from the adapter or the battery, and outputting a determined power source information; and a control part stored in the BIOS ROM, and controlling the video chip to lower the vertical frequency of the LCD device when the power supply receives the electric power from the battery to be less than the vertical frequency when the power supply receives the electric power from the adapter, based upon the determined power source information.

According to an aspect of the invention, the control part comprises a video BIOS having a plurality of vertical frequency information according to a power source whether from the battery or the adapter, and controlling the video chip to output the vertical frequency according to the vertical frequency information in correspondence to the determined power source information.

According to an aspect of the invention, the control part further comprises a system BIOS receiving the determined power source information from the microprocessor while the portable computer operates, and commanding the video BIOS to change the vertical frequency of the video chip when a power source is changed during a running time of the portable computer.

According to an aspect of the invention, the system BIOS commands the video BIOS to turn off the LCD device when the power source is changed, and the video BIOS controls the video chip to stop outputting video signals.

According to an aspect of the invention, the control part sets up the video chip to output the vertical frequency of 50 Hz and 60 Hz when the power supply receives the electric power from the battery and the adapter, respectively.

According to another aspect of the present invention, the present invention may be also achieved by providing a method of controlling a portable computer comprising a system board mounted with devices, such as a video chip, etc., a power supply receiving electric power from a battery or an adapter, a BIOS ROM including information controlling various system devices and initializing the system board in a POST procedure, and an LCD device displaying a picture based on a vertical frequency transmitted from the video chip, the method comprising determining whether the power supply receives the electric power from the battery or the adapter; changing the vertical frequency when the power supply receives the electric power from the battery as compared to the vertical frequency when the power supply receives the electric power from the adapter; and controlling the video chip to output at a lowered vertical frequency.

According to an aspect of the invention, the BIOS ROM comprises a system BIOS initializing the devices of the system board, and a video BIOS setting up the vertical frequency of the video chip, in the POST procedure of the portable computer, wherein the changing of the vertical frequency comprises transmitting a determined power source information to the video BIOS; and allowing the video BIOS to set up the vertical frequency of the video chip according to the determined power source information.

According to an aspect of the invention, in a running time of the portable computer, the changing of the vertical frequency comprises determining whether a power source of the power supply is changed or not; transmitting the determined power source information to the system BIOS; and allowing the system BIOS to command the video BIOS to set up the vertical frequency according to the determined power source information.

According to an aspect of the invention, in the running time of the portable computer, the changing of the vertical frequency when the power source is changed further comprises allowing the system BIOS to command the video BIOS to prevent the video chip from outputting a video signal.

According to an aspect of the invention, the changing of the vertical frequency comprise changing the vertical frequency into 50 Hz and 60 Hz when the power supply receives the electric power from the battery and the adapter, respectively.

### BRIEF DESCRIPTION OF THE DRAWINGS

The advantages of the present invention will become apparent and more readily appreciated from the following description of the embodiments, taken in conjunction with the accompanying drawings of which:

FIG. 1 is a control block diagram of a portable computer according to an embodiment of the present invention;

FIG. 2 is a control flowchart in a POST procedure of the portable computer shown in FIG. 1; and

FIG. 3 is a control flowchart in a running time of the portable computer shown in FIG. 1.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

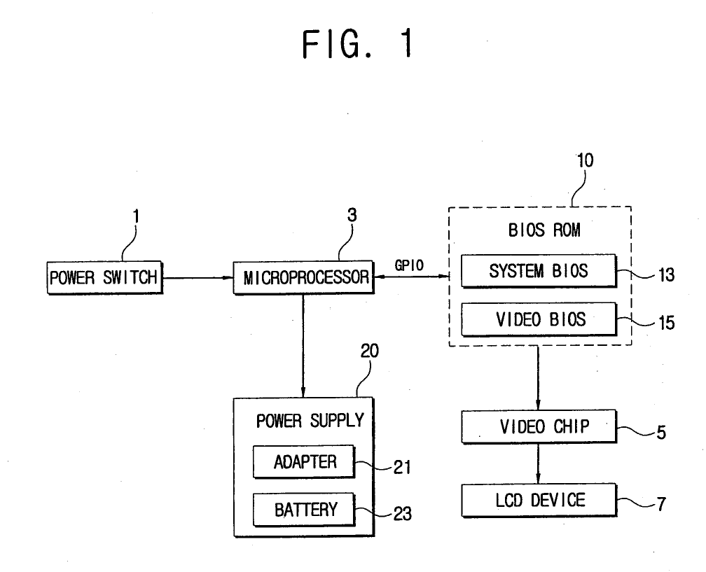

As shown in FIG. 1, a portable computer according to an embodiment of the present invention comprises a power switch 1, a power supply 20 receiving electric power from an AC adapter 21 (adapter) or a battery 23 and supplying the electric power to devices, a BIOS (basic input/output system) ROM (read only memory) 10 storing a BIOS program performing a POST procedure to initialize connected/available devices when the portable computer is turned on, and setting up a vertical frequency transmitted from a video chip 5 to an LCD device 7, the LCD device 7 displaying a picture by processing the vertical frequency, a horizontal frequency, and RGB (red, green and blue) video signals output from the video chip 5, and a microprocessor 3 determining whether the power supply 20 receives the electric power from the adapter 21 or the battery 23, and transmitting a determined power source information to the BIOS program of the BIOS ROM 10. Typically, the microprocessor 3 can be a conventional general purpose controller providing power management functions/processes with respect to supply of power from power sources, such as an adapter or a battery, to operational components of a portable computer and the microprocessor 3 is in communication with the BIOS ROM 10 via a conventional general purpose I/O bus to provide detected and/or determined power source information. In particular, according to the present invention, the microprocessor 3 detects and/or determines a power source, such as a battery or an adapter, and transmits the determined power source to the BIOS ROM 10.

The BIOS program stored in the BIOS ROM 10 comprises a system BIOS 13 determining what devices are available in the POST procedure and initializing the available devices, and a video BIOS 15 setting up the vertical frequency output from the video chip 5 to the LCD device 7 in response to a command of the system BIOS 13.

According to an aspect of the present invention, while the POST procedure is performed, the video BIOS 15 sets up the vertical frequency of the video chip 5 based on the determined power source information transmitted from the microprocessor 3. That is, the vertical frequency output from the video chip 5 is set up to be lowered when the power supply 20 receives the electric power from the battery 23 as compared to the vertical frequency when the power supply 20 receives the electric power from the adapter 21.

On the other hand, while the portable computer is being operated, if a power source is changed from the adapter 21 into the battery 23, or from the battery 23 into the adapter 21, the system BIOS 13 commands the video BIOS 15 to set up the vertical frequency for the LCD device 7 based upon the determined power source information (e.g., identifiers indicating power source, control signals indicating power source, etc.) transmitted from the microprocessor 3. Simultaneously, the system BIOS 13 transmits a frequency ID (identification) corresponding to the adapter 21 or the battery 23 to the video BIOS 15 in response to the power source information. Then, the video BIOS 15 controls the video chip 5 to output the vertical frequency which is changed in correspondence to the frequency ID to the LCD device 7. Herein, the video BIOS 15 implements information modules (program segments) on a plurality of vertical frequencies for driving the LCD device 7 and the frequency ID from BIOS 13 invokes a corresponding vertical frequency information/modules in the video BIOS 15.

Typically, a vertical frequency ID of 50 Hz is selected when the power supply 20 receives the electric power from the battery 23, or a vertical frequency ID of 60 Hz is selected when the power supply 20 receives the electric power from the adapter 21. Further, before the BIOS 13 commands the VIDEO BIOS 15 to alter the vertical frequency, the system BIOS 13 commands the video BIOS 15 to turn off the LCD device 7 so as to protect the LCD device 7 against the sudden alteration of the vertical frequency. Accordingly, the video BIOS 15 controls the video chip 5 to stop outputting the RGB video signals in response to the turn off command from the system BIOS 13.

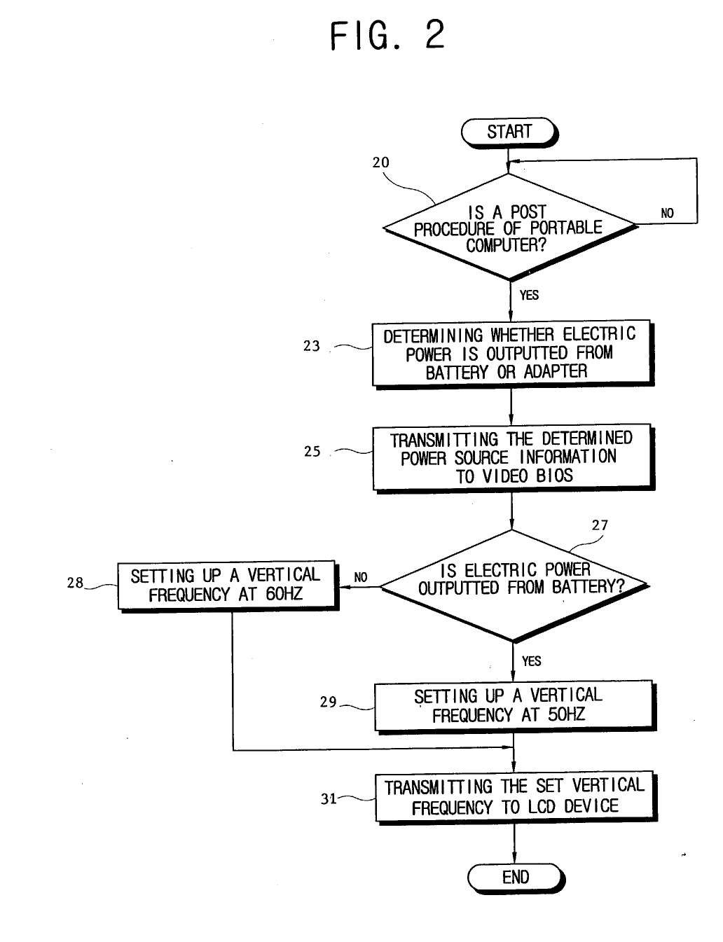

FIG. 2 is a control flowchart in a POST procedure of the portable computer shown in FIG. 1. When the power switch 1 is turned on, at operation 20, the portable computer starts performing the POST procedure so as to initialize the devices. At operation 23, the microprocessor 3 determines whether the power supply 20 receives the electric power from the adapter 21 or the battery 23. At operation 25, the determined power source information is transmitted to the video BIOS 15 of the BIOS ROM 10 via the system BIOS 13. After operation 25, the video BIOS 15 sets up the vertical frequency output from the video chip 5 according to the determined and received power source information from the microprocessor 3. More particularly, at operation 27, if the power supply 20 receives the electric power from the battery 23, at operation 29, the video BIOS 15 sets up the video chip 5 to output a vertical frequency of 50 Hz. Oppositely, if at operation 27, it is determined that the power supply 20 receives the electric power from the adapter 21, at operation 28, the video BIOS 15 sets up the video chip 5 to output a vertical frequency of 60 Hz. At operation 31, the video chip 5 outputs the vertical frequency changed according to the power source to the LCD device 7.

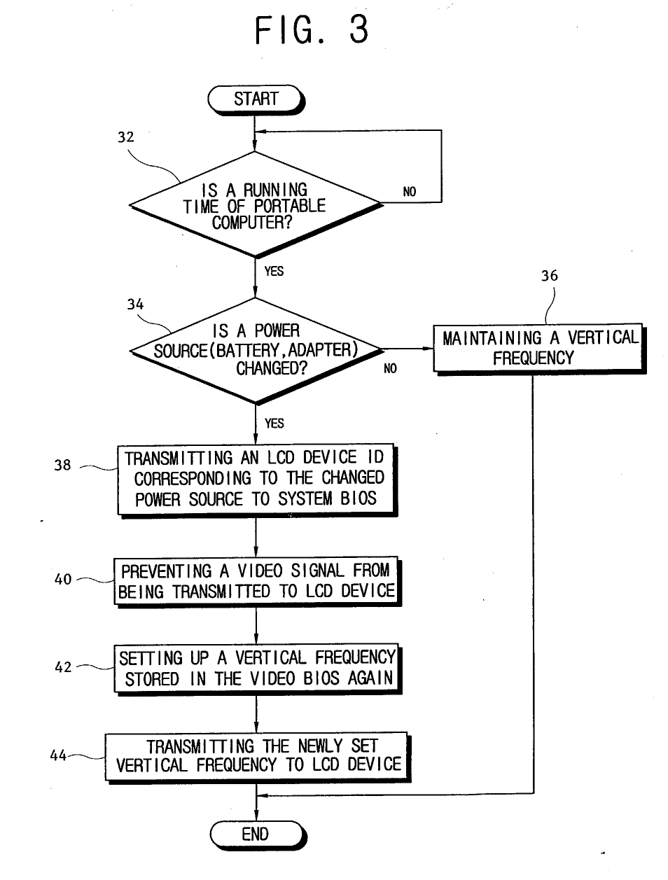

FIG. 3 is a control flowchart in a running time of the portable computer shown in FIG. 1. When, at operation 32, the portable computer is in a running time, at operation 34 the microprocessor 3 determines whether the power source is changed. At operation 34, when the power source is changed from the adapter 21 into the battery 23, or from the battery 23 to the adapter 21, at operation 38 the microprocessor 3 transmits the determined power source information (e.g., an LCD device ID correspondence to the changed power source) to the system BIOS 13 of the BIOS ROM 10. At this time, at operation 40, the system BIOS 13 commands the video BIOS to prevent the LCD device 7 from receiving the RGB video signals, so that the video BIOS 15 controls the video chip 5 to stop outputting the RGB video signals to the LCD device 7. Thereafter, at operation 42, based upon the determined power source information transmitted from the microprocessor 3, the system BIOS 13 commands the video BIOS 15 to set up the vertical frequency again by transmitting the ID received from the microprocessor 3 to the video BIOS 15. More particularly, at operation 42, the video BIOS 15 executes a vertical frequency program segment in response to the received ID to control the video chip 5 to output a vertical frequency, which is changed in correspondence to the ID, to the LCD device 7. Therefore, at operation 44 the video chip 5 outputs the vertical frequency changed according to the power source to the LCD device 7. Consequently, the LCD device 7 operates based upon a different vertical frequency according to the change of the power source from the adapter 21 to the battery 23 or from the battery 23 to the adapter 21.

According to an aspect of the invention, at operation 44, the video chip 5 outputs the vertical frequency of 50 Hz when the power supply 20 receives the electric power from the battery 23 and outputs the vertical frequency of 60 Hz when the power supply 20 receives the electric power from the adapter 21. On the other hand, at operation 34, if it is determined that the power source is not changed, at operation 36 the vertical frequency transmitted from the video chip 5 to the LCD device 7 is also not changed.

According to the present invention, when the portable computer is in the POST procedure or the running time, if the power supply 20 receives the electric power from the battery 23, the vertical frequency of the video chip 5 is lowered, typically to be below or less than 60 Hz, thereby reducing power consumption. Further, in this case, the system BIOS may control the microprocessor to decrease a voltage applied to a back light allowing the LCD device to lighten, thereby lowering the brightness of the back light and further reducing power consumption. Further, the vertical frequency for the LCD device can be set up to be lowered when the power supply receives the electric power from the battery and the vertical frequency for the LCD device can be increased when the power supply receives power from the adapter.

As described above, the present invention provides a portable computer and a method of controlling the same, which can reduce power consumption by lowering a vertical frequency for an LCD device while being operated by a battery. The processes of the present invention providing a power consumption management function depending on a power source type and a vertical frequency of a display can be implemented in software and/or hardware, and typically are embodied as software in the microprocessor 3 and the BIOS ROM 10. Typically, the processes of the present invention are implement in software in an existing power management processor and BIOS ROM programs of a portable computer or a portable/hand-held computing device. The present invention provides a method and system of detecting a type of or change in a power source to a device and changing a vertical frequency output to a display, such as liquid crystal display, of the device in response to the detected power source type or change. In particular, the power source can be a battery and an AC adapter, and the vertical frequency of a display is lowered in a battery mode compared to the vertical frequency in an AC mode. Further, typically the vertical frequency of a display is lowered or set to 50 Hz from 60 Hz if receiving power from the battery and the vertical frequency is increased or set to 60 Hz if receiving power from the AC adapter. Further, the vertical frequency of a display can be altered in a range between 50 Hz and 60 Hz according to a power source to reduce power consumption.

Although a 50 Hz display vertical frequency is described when in a battery mode, the present invention is not limited to such configuration, and the vertical frequency can be less than or below 50 Hz. In a case the LCD display vertical frequency is lowered to be less than 50 Hz, because of an inverter in a typical LCD, a wave phenomenon (wave pattern) may occur, which a user may perceive. Therefore, optimally, the LCD display vertical frequency should be lowered to a frequency a user cannot perceive, corresponding to a human eye's blinking. Of course, to further prolong power supply, the display vertical frequency could be lowered to be below such optimal lowered setting, if desired by a user. Further, the present invention's power management based upon display vertical frequency may be user configurable.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A portable computer comprising:
a power supply receiving electric power from an adapter or a battery;
an LCD device displaying a picture based on a vertical frequency transmitted from a video chip;
a microprocessor determining whether the power supply receives the electric power from the adapter or the battery, and outputting a determined power source information; and
a controller controlling the video chip to lower the vertical frequency for the LCD device when the power supply receives the electric power from the battery to be less than the vertical frequency when the power supply receives the electric power from the adapter based upon the determined power source information.

2. The portable computer according to claim 1, wherein the controller comprises a video BIOS having a plurality of vertical frequency information according to the power source whether from the battery or the adapter, and controlling the video chip to output the vertical frequency in correspondence to the vertical frequency information according to the determined power source information.

3. The portable computer according to claim 2, wherein the controller further comprises a system BIOS receiving the determined power source information from the microprocessor while the portable computer operates, and commanding the video BIOS to change the vertical frequency of the video chip when the power source is changed.

4. The portable computer according to claim 3, wherein the system BIOS commands the video BIOS to turn off the LCD device when the power source is changed, and the video BIOS controls the video chip to stop outputting video signals.

5. The portable computer according to claim 1, wherein the controller sets up the video chip to output a vertical frequency of 50 Hz and 60 Hz when the power supply receives the electric power from the battery and the adapter, respectively.

6. A method of controlling a portable computer, comprising:
determining whether a power supply to the computer receives electric power from a battery or an adapter;
changing a vertical frequency setting of an LCD device of the computer by lowering the setting when determined that the power supply receives the electric power from the battery to be less than the vertical frequency when the power supply receives the electric power form the adapter; and
controlling a video chip to output a changed vertical frequency to the LCD device corresponding to the changed vertical frequency setting.

7. The method according to claim 6, wherein the vertical frequency setting is changed during a POST process of the portable computer.

8. The method according to claim 7, wherein the vertical frequency setting is changed during operation of the portable computer.

9. The method according to claim 8, further comprising:
preventing the video chip from outputting a video signal to the LCD device before lowering the vertical frequency setting.

10. The method according to claim 6, wherein the vertical frequency setting is set to 50 Hz and 60 Hz when the power supply receives the electric power from the battery and the adapter, respectively.

11. A method, comprising:
detecting a power source type to a device; and
changing a vertical frequency output to a liquid crystal display of the device in response to the detected power source type.

12. The method of claim 11, wherein the type of power source is a battery or an AC adapter and the method further comprises lowering the vertical frequency if the power source is the battery.

13. The method of claim 11, wherein the vertical frequency is changed in a range of 60 Hz and 50 Hz.

14. The method of claim 12, wherein the vertical frequency is lowered to less than 50 Hz if the power source is the battery.

15. A computer receiving power from two or more power sources, the computer comprising:
a liquid crystal display;
a power supply receiving the power from the two or more power sources; and
a programmed computer processor changing a vertical frequency output to the liquid crystal display in response to a type of power source supplying power to the power supply.

16. The computer of claim 15, wherein the power sources comprise a battery and an AC adapter, and the programmed computer processor lowers the vertical frequency if the power source is the battery.

17. The computer of claim 15, wherein the vertical frequency is changed in a range of 60 Hz and 50 Hz.
